(19) United States
(12) Patent Application Publication
(10) Pub. No.: US 2025/0190785 A1
(43) Pub. Date: Jun. 12, 2025

(54) DEPLOYING A NEURAL NETWORK TO A NEW EDGE SERVER IN AN EDGE COMPUTING ENVIRONMENT

(71) Applicant: INTERNATIONAL BUSINESS MACHINES CORPORATION, ARMONK, NY (US)

(72) Inventors: ANDREW C. M. HICKS, HIGHLAND, NY (US); JOHN S. WERNER, FISHKILL, NY (US); RAFAELA FROTA, POUGHKEEPSIE, NY (US); FAEZEH GHOLAMI, RIDGEWOOD, NJ (US)

(21) Appl. No.: 18/536,977

(22) Filed: Dec. 12, 2023

(51) Int. Cl. G06N 3/08; G06N 3/04

(52) U.S. Cl. CPC G06N 3/08; G06N 3/04

(57) ABSTRACT

Deploying a neural network to a new edge server in an edge computing environment includes deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. Each of the edge servers stores edge devices information including a physical location of each edge device that accessed the independently trained neural network operating at the edge server. A new edge neural network is generated for deployment to the new edge server, including performing neural network breeding based on the independently trained neural networks and the stored edge devices information, and based on anticipated edge devices information for edge devices expected to access the new edge server.

### BACKGROUND

The present disclosure relates to methods, apparatus, and products for deploying a neural network to a new edge server in an edge computing environment.

### SUMMARY

According to embodiments of the present disclosure, various methods, apparatus, and products for deploying a neural network to a new edge server in an edge computing environment are described herein. In some aspects, deploying a neural network to a new edge server in an edge computing environment includes deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. Each of the edge servers stores edge devices information including a physical location of each edge device that accessed the independently trained neural network operating at the edge server. A new edge neural network is generated for deployment to the new edge server, including performing neural network breeding based on the independently trained neural networks and the stored edge devices information, and based on anticipated edge devices information for edge devices expected to access the new edge server.

### BRIEF DESCRIPTION OF THE DRAWINGS

FIG. 1 sets forth an example computing environment according to aspects of the present disclosure.

FIG. 2 sets forth an example implementation of a system for deploying a neural network to a new edge server in an edge computing environment according to aspects of the present disclosure.

FIG. 3 sets forth a flowchart of an example method for deploying a neural network to a new edge server in an edge computing environment according to aspects of the present disclosure.

FIG. 4 sets forth a flowchart of an example method for generating a new edge neural network for a new edge server according to aspects of the present disclosure.

FIG. 5 sets forth a flowchart of an example method for deploying a neural network to a new edge server in an edge computing environment according to another aspect of the present disclosure.

### DETAILED DESCRIPTION

Neural networks may be deployed in edge computing environments to increase bandwidth and reduce latency for end users. It may be useful to continuously train the neural network such that it keeps improving over time. When neural networks are individually trained at edge systems, one or more edge systems may drift and diverge from other edge systems. In some instances, it may be useful to allow edge nodes to train differently and drift from one another to adapt to the incoming data within a specific physical location (e.g., near the edge node). When deploying a neural network to a new edge node, it may be difficult to know which of the existing already trained edge neural networks is optimal for the location of the new edge node.

Some examples disclosed herein are directed to deploying an optimal neural network for a new edge node in an edge computing environment. Some examples utilize input data from a physical location where a new edge node is to be deployed, compare that input data to the input data that was used to train neural networks on other existing edge nodes, and determine which of the current edge neural networks to breed and the weight percentage of each to most closely match the expected conditions (e.g., inputs) at the new edge node.

In some examples, an initial centralized neural network is created in a cloud data center using training data at the cloud data center. In some examples, the cloud data center deploys individual neural networks (e.g., copies of the centralized neural network) to edge servers (also referred to herein as edge nodes), and allows them to train differently and drift from one another to adapt to the incoming data within their specific physical locations. As the individual edge neural networks are operated at the edge servers, each edge server captures and stores edge devices information, which includes neural network inputs provided by each edge device that accessed the edge neural network at that edge server along with a physical location of each edge device. When a new edge server is to be deployed, the existing edge servers send their respective edge neural networks and corresponding edge devices information to the cloud data center. The cloud data center also receives and/or determines anticipated edge devices information, which includes information regarding edge devices that are expected to access the new edge server, including neural network inputs expected to be provided by these edge devices. The anticipated edge devices may be identified, for example, based on how close their physical location is to the physical location of the new edge server (e.g., edge devices that are in close physical proximity to the new edge server may be expected to access the new edge server). The cloud data center compares the anticipated edge devices information to the edge devices information provided by the existing edge servers, and identifies, based on this comparison, which of the existing edge neural networks to breed and a weight factor for each of these neural networks. The cloud data center then breeds the identified edge neural networks using the identified weight factors to generate a new edge neural network, and deploys the new edge neural network to the new edge server.

In some examples, at periodic intervals (e.g., when a time threshold is reached, such as 1 week, 1 month, etc.), the edge neural network at each of the edge servers may be shared with the other edge servers. The periodic interval may be set by a network administrator. The periodic interval may be triggered when a preset amount of time has expired or a preset amount of drift has occurred in one or more of the individual neural networks. In some examples, each edge server may perform a test run on the incoming edge neural networks using the edge devices information from that edge server to determine a fitness score (also referred to herein as a fitness measure) for each of the incoming edge neural networks. If a high fitness score is observed at an edge server for a given incoming neural network (e.g., the fitness score exceeds a score threshold indicating that it performed well), breeding may be performed between that incoming edge neural network and the edge neural network that was previously operating on that edge server to generate an updated or optimized edge neural network that now accounts for additional inputs that may be observed. Other incoming edge neural networks that do not meet a fitness threshold may be discarded and not used in the breeding and may continue to be used as is on the original edge servers that they came from. After breeding, each edge server may discard the edge neural networks received from other edge servers, and each edge server is left with only one edge neural network that was either breeded with one or more other edge neural networks or left alone because no other edge neural networks met the fitness score threshold. This process may be periodically repeated to provide continual updating of the edge neural networks at the edge servers.

Some examples disclosed herein use NeuroEvolution of Augmenting Topologies (NEAT) for generating a neural network to be deployed to a new edge server. In some examples, the neural network breeding may be performed using a hypercube-based NEAT (hyperNEAT) calculation which performs a weighted average, based on comparison percentages, of the parameters extracted from each neuron. Some examples may be implemented as a service (aaS) for deployment of artificial intelligence (AI) in edge computing environments.

An example of the present disclosure is directed to a method for deploying a neural network to a new edge server in an edge computing environment, including deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The method includes storing, by each of the edge servers, edge devices information including a physical location of each edge device that accessed the independently trained neural network operating at the edge server. The method includes generating a new edge neural network for deployment to the new edge server, including performing neural network breeding based on the independently trained neural networks and the stored edge devices information, and based on anticipated edge devices information for edge devices expected to access the new edge server.

Examples of the method include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural networks such that they keep improving over time. Some examples include the technical feature of storing, by each of the edge servers, edge devices information including a physical location of each edge device that accessed the independently trained neural network operating at the edge server. This technical feature yields the technical effect of maintaining information that may be used to help generate a new edge neural network that is immediately able to provide accurate results. Some examples include the technical features of generating a new edge neural network for deployment to the new edge server, including performing neural network breeding based on the independently trained neural networks and the stored edge devices information, and based on anticipated edge devices information for edge devices expected to access the new edge server. This technical feature yields the technical effect of generating customized neural networks for new edge servers with immediate good performance right after deployment, while also minimizing network congestion and latency issues.

The method may also include receiving, at a cloud-based data center, a request for the new edge server including a physical location of the new edge server; sending, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and deploying, from the cloud-based data center to the new edge server, the new edge neural network. This has the technical effect of allowing the neural networks to be continually trained and improved over time based on inputs at the edge servers, and using these trained and improved neural networks by a cloud-based data center to generate, based on a received request, a customized neural network for a new edge server with immediate good performance right after deployment.

In some examples of the method, for each of the edge servers, the stored edge devices information further includes inputs provided by edge devices to the independently trained neural network operating at the edge server. This has the technical effect of maintaining information that may be used to identify edge neural networks that are good candidates for breeding.

In some examples of the method, the anticipated edge devices information includes inputs expected to be provided by edge devices to the new edge server. This has the technical effect of maintaining additional information that may be used to identify edge neural networks that are good candidates for breeding based on expected inputs at the new edge server.

In some examples, the method further includes comparing, for each of the edge servers, the edge devices information from the edge server to the anticipated edge devices information for the new edge server to determine a comparison percentage corresponding to the independently trained neural network operating on the edge server. This has the technical effect of determining comparison percentages that may be used to identify edge neural networks that are good candidates for breeding, and that may be used as weight factors in the neural network breeding.

In some examples of the method, the neural network breeding includes discarding any copies of the independently trained neural networks that have a corresponding comparison percentage below a threshold comparison percentage. This has the technical effect of improving the performance of the neural network for the new edge server by discarding any of the copies of the independently trained neural networks that have a relatively low comparison percentage.

In some examples of the method, the neural network breeding includes selecting top matching copies of the independently trained neural networks to be used for the neural network breeding based on the comparison percentage corresponding to each of the copies of the independently trained neural networks. This has the technical effect of improving the performance of the neural network for the new edge server by selecting and using top matching ones of the copies of the independently trained neural networks.

In some examples of the method, the neural network breeding includes performing a hyperNEAT calculation that includes determining a weighted average, based on the comparison percentages, of parameters extracted from neurons in one or more of the copies of the independently trained neural networks. This has the technical effect of improving the performance of the neural network for the new edge server by using a weighted average based on the comparison percentages so that higher comparison percentages may provide a greater influence.

Another example of the present disclosure is directed to an apparatus for deploying a neural network to a new edge server in an edge computing environment, which includes a processing device, and a memory operatively coupled to the processing device. The memory stores computer program instructions that, when executed, cause the processing device to deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The memory also stores computer program instructions that, when executed, cause the processing device to store, by each of the edge servers, edge devices information including a physical location of each edge device that accessed the independently trained neural network operating at the edge server. The memory also stores computer program instructions that, when executed, cause the processing device to generate a new edge neural network for deployment to the new edge server, including performing neural network breeding based on the independently trained neural networks and the stored edge devices information, and based on anticipated edge devices information for edge devices expected to access the new edge server.

Examples of the apparatus include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural networks such that they keep improving over time. Some examples include the technical feature of storing, by each of the edge servers, edge devices information including a physical location of each edge device that accessed the independently trained neural network operating at the edge server. This technical feature yields the technical effect of maintaining information that may be used to help generate a new edge neural network that is immediately able to provide accurate results. Some examples include the technical features of generating a new edge neural network for deployment to the new edge server, including performing neural network breeding based on the independently trained neural networks and the stored edge devices information, and based on anticipated edge devices information for edge devices expected to access the new edge server. This technical feature yields the technical effect of generating customized neural networks for new edge servers with immediate good performance right after deployment, while also minimizing network congestion and latency issues.

The memory of the apparatus may also store computer program instructions that, when executed, cause the processing device to receive, at a cloud-based data center, a request for the new edge server including a physical location of the new edge server; send, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and deploy, from the cloud-based data center to the new edge server, the new edge neural network. This has the technical effect of allowing the neural networks to be continually trained and improved over time based on inputs at the edge servers, and using these trained and improved neural networks by a cloud-based data center to generate, based on a received request, a customized neural network for a new edge server with immediate good performance right after deployment.

In some examples of the apparatus, for each of the edge servers, the stored edge devices information further includes inputs provided by edge devices to the independently trained neural network operating at the edge server. This has the technical effect of maintaining information that may be used to identify edge neural networks that are good candidates for breeding.

In some examples of the apparatus, the anticipated edge devices information includes inputs expected to be provided by edge devices to the new edge server. This has the technical effect of maintaining additional information that may be used to identify edge neural networks that are good candidates for breeding based on expected inputs at the new edge server.

The memory of the apparatus may also store computer program instructions that, when executed, cause the processing device to compare, for each of the edge servers, the edge devices information from the edge server to the anticipated edge devices information for the new edge server to determine a comparison percentage corresponding to the independently trained neural network operating on the edge server. This has the technical effect of determining comparison percentages that may be used to identify edge neural networks that are good candidates for breeding, and that may be used as weight factors in the neural network breeding.

In some examples of the apparatus, the neural network breeding includes discarding any copies of the independently trained neural networks that have a corresponding comparison percentage below a threshold comparison percentage. This has the technical effect of improving the performance of the neural network for the new edge server by discarding any of the copies of the independently trained neural networks that have a relatively low comparison percentage.

In some examples of the apparatus, the neural network breeding includes selecting top matching copies of the independently trained neural networks to be used for the neural network breeding based on the comparison percentage corresponding to each of the copies of the independently trained neural networks. This has the technical effect of improving the performance of the neural network for the new edge server by selecting and using top matching ones of the copies of the independently trained neural networks.

In some examples of the apparatus, the neural network breeding includes performing a hyperNEAT calculation that includes determining a weighted average, based on the comparison percentages, of parameters extracted from neurons in one or more of the copies of the independently trained neural networks. This has the technical effect of improving the performance of the neural network for the new edge server by using a weighted average based on the comparison percentages so that higher comparison percentages may provide a greater influence.

Another example of the present disclosure is directed to a computer program product for continual neural network training in an edge computing environment, comprising a computer readable storage medium, wherein the computer readable storage medium comprises computer program instructions that, when executed: deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks; store, by each of the edge servers, edge devices information including a physical location of each edge device that accessed the independently trained neural network operating at the edge server; and generate a new edge neural network for deployment to the new edge server, including performing neural network breeding based on the independently trained neural networks and the stored edge devices information, and based on anticipated edge devices information for edge devices expected to access the new edge server.

Examples of the computer program product include various technical features that yield technical effects that provide various improvements to computer technology. For instance, some examples include the technical feature of deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. This technical feature yields the technical effect of continually training the neural networks such that they keep improving over time. Some examples include the technical feature of storing, by each of the edge servers, edge devices information including a physical location of each edge device that accessed the independently trained neural network operating at the edge server. This technical feature yields the technical effect of maintaining information that may be used to help generate a new edge neural network that is immediately able to provide accurate results. Some examples include the technical features of generating a new edge neural network for deployment to the new edge server, including performing neural network breeding based on the independently trained neural networks and the stored edge devices information, and based on anticipated edge devices information for edge devices expected to access the new edge server. This technical feature yields the technical effect of generating customized neural networks for new edge servers with immediate good performance right after deployment, while also minimizing network congestion and latency issues.

In some examples of the computer program product, the computer readable storage medium may further comprise computer program instructions that, when executed: receive, at a cloud-based data center, a request for the new edge server including a physical location of the new edge server; send, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and deploy, from the cloud-based data center to the new edge server, the new edge neural network. This has the technical effect of allowing the neural networks to be continually trained and improved over time based on inputs at the edge servers, and using these trained and improved neural networks by a cloud-based data center to generate, based on a received request, a customized neural network for a new edge server with immediate good performance right after deployment.

In some examples of the computer program product, the computer readable storage medium may further comprise instructions that, when executed: compare, for each of the edge servers, the edge devices information from the edge server to the anticipated edge devices information for the new edge server to determine a comparison percentage corresponding to the independently trained neural network operating on the edge server. This has the technical effect of determining comparison percentages that may be used to identify edge neural networks that are good candidates for breeding, and that may be used as weight factors in the neural network breeding.

In some examples of the computer program product, the neural network breeding includes performing a hyperNEAT calculation that includes determining a weighted average, based on the comparison percentages, of parameters extracted from neurons in one or more of the copies of the independently trained neural networks. This has the technical effect of improving the performance of the neural network for the new edge server by using a weighted average based on the comparison percentages so that higher comparison percentages may provide a greater influence.

Some examples disclosed herein utilize input data from a physical location where a new edge node is to be deployed; compare that input data to the input data that was used to train edge neural networks on other existing edge nodes; determine which of the current edge neural networks to breed and the weight percentage of each to most closely match the expected conditions (e.g., inputs) of the new edge node; and deploy the bred neural network to the new edge node. Some examples optimize deployment of customized neural networks for new edge nodes and improves their performance from the first day of the new edge node coming online, while minimizing network congestion and latency issues.

In some examples, each edge server may contain one individual neural network. Some examples of the present disclosure use unsupervised models and unsupervised learning. Some examples are directed to deploying an optimal neural network for a new edge node in an edge computing environment such that the neural network is immediately able to perform well and provide accurate results. In some examples, different edge neural networks are periodically shared between edge servers, and these edge servers each run a test (e.g., a 2 hour test) to determine how well the other edge neural networks perform on their inputs, and breed them if a high fitness is observed during the test run. Some examples also look at subsets of neural activation maps. Some examples reduce data congestion within an edge computing environment to improve network performance. Some examples use fitness measurements at edge compute nodes to breed edge neural networks and update the edge neural network at each edge server. Some examples update edge neural networks without sending all training data seen at the edge nodes back to a centralized server which could put significant strain on a network. This strain could increase latency and increase power of all nodes back to the centralized location. Some examples save on power of systems used to support an edge network.

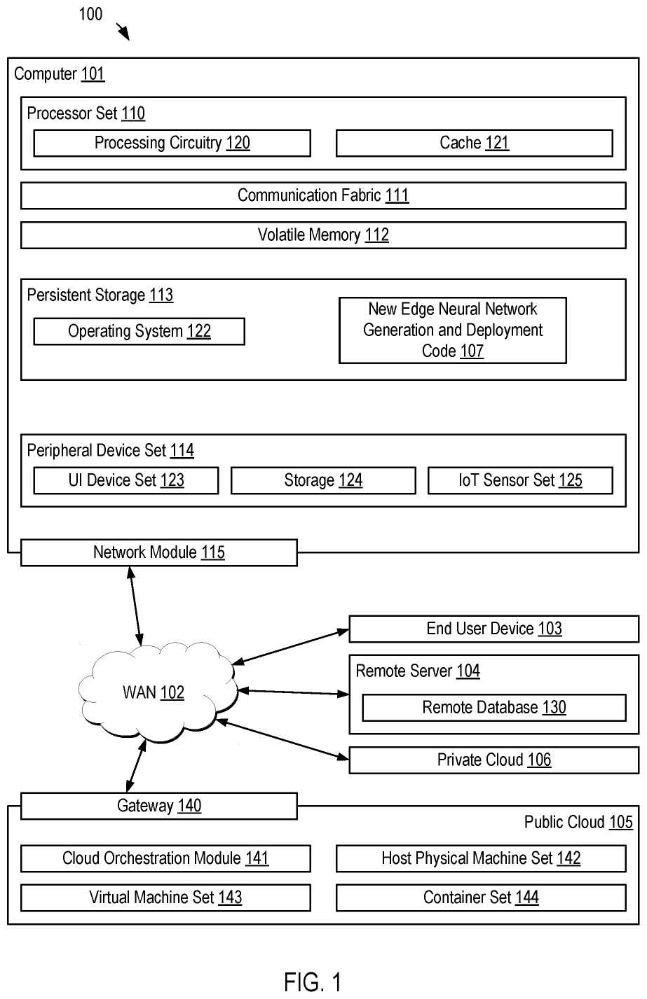

FIG. 1 sets forth an example computing environment according to aspects of the present disclosure. Computing environment 100 contains an example of an environment for the execution of at least some of the computer code involved in performing the various methods described herein, such as new edge neural network generation and deployment code 107. In addition to new edge neural network generation and deployment code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and new edge neural network generation and deployment code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in new edge neural network generation and deployment code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in new edge neural network generation and deployment code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

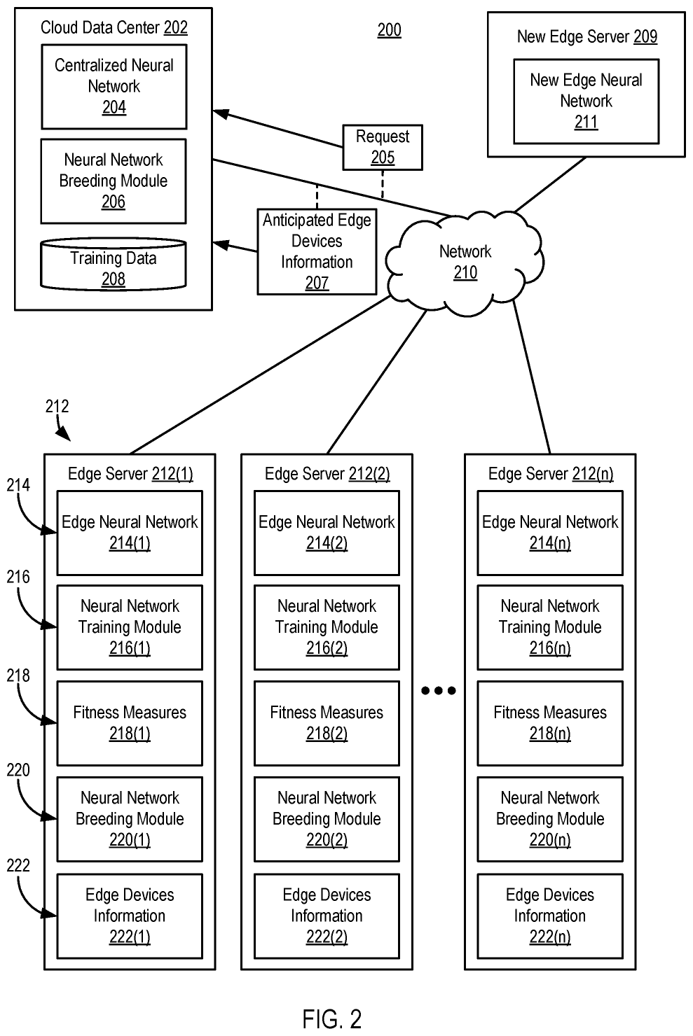

FIG. 2 sets forth an example implementation of a system 200 for deploying a neural network to a new edge server in an edge computing environment according to aspects of the present disclosure. System 200 includes cloud data center 202, and a plurality of edge servers 212(1)-212(n) (collectively referred to as edge servers 212). Cloud data center 202 is communicatively coupled to the edge servers 212 via network 210. Network 210 may be a wired or wireless network, and may use any communication protocol that allows data to be transferred between components of the system 200, including, for example, PCIe, I2C, Bluetooth, Wi-Fi, Cellular (e.g., 3G, 4G, 5G), Ethernet, fiber optics, as well as others. Network 210 may also include fog nodes in some embodiments.

During operation according to some examples, cloud data center 202 may receive a request 205 for a new edge server 209. In some examples, the request 205 includes the physical location of the new edge server 209. New edge server 209 may be deployed, for example, in a location where there is significant neural network utilization by end users, but the end users are physically far from existing edge servers (e.g., edge servers 212) and may experience longer latency. In response to receiving the request 205, cloud data center 202 generates and deploys a new edge neural network 211 to the new edge server 209 as described in further detail below.

Cloud data center 202 includes centralized neural network 204, neural network breeding module 206, and training data 208. Cloud data center 202 may include one or more computing devices (e.g., servers, compute nodes, etc.), which may be scattered among one or more different physical locations. Edge servers 212(1)-212(n) respectively include edge neural networks 214(1)-214(n) (collectively referred to as edge neural networks 214), neural network training modules 216(1)-216(n) (collectively referred to as neural network training modules 216), fitness measures 218(1)-218(n) (collectively referred to as fitness measures 218), neural network breeding modules 220(1)-220(n) (collectively referred to as neural network breeding modules 220), and edge devices information 222(1)-222(n) (collectively referred to as edge devices information 222). In an example, new edge neural network generation and deployment code 107 (FIG. 1) includes neural network breeding module 206, neural network training modules 216, and neural network breeding modules 220. Edge servers 212 may be deployed in different physical locations such that the operations can be performed closer to end users of the system. Edge neural networks 214 receive inputs from end users (e.g., edge devices) and supply corresponding outputs to the end users.

Cloud data center 202 deploys copies of the centralized neural network 204 to the edge servers 212, which store their copies as edge neural networks 214. In an example, the centralized neural network 204 is initially built and trained at the cloud data center 202 using training data 208 during development. After deployment of the centralized neural network 204 to the edge servers 212 by the cloud data center 202, the edge neural networks 214 operate independently from each other and are trained and updated by their respective neural network training modules 216 based on the inputs seen at their respective edge servers 212. Each of the edge servers 212 stores edge devices information 222 associated with the edge neural network 214 operating on that edge server 212. The edge devices information 222 for each edge server 212 may be a metadata amalgamation that includes, for example, a physical location of each edge device that accessed the edge server 212, inputs and outputs of the edge server's edge neural network 214 for the accesses by each edge device, and other metadata associated with each edge device that accessed the edge server 212. Thus, each of the edge servers 212 tracks the physical location and other metadata of the edge devices that connect to that edge server 212 and use its edge neural network 214.

In some examples, at periodic intervals, each of the edge servers 212 sends its edge neural network 214 to the other ones of the edge servers 212 for updating of the edge neural networks 214. The periodicity of the updates to the edge neural networks 214 may be dependent on use case (e.g., once per day, once per week, etc.). Each of the edge servers 212 then calculates fitness measures 218, which includes a fitness measure for each of the received edge neural networks 214 and is calculated based on the edge devices information 222 stored at that edge server 212. Each of the fitness measures 218 provides a measure of performance of its associated edge neural network 214. In some examples, the fitness measures 218 may include memory allocation, input/output (I/O) through-put, score in a game, obtaining a system error, as well as others. The neural network breeding module 220 at each of the edge servers 212 then performs, based on the fitness measures 218, a breeding operation between the edge neural network 214 at that edge server 212 and one or more of the edge neural networks 214 received by that edge server 212 to update the edge neural network 214 at that edge server 212.

As mentioned above, in response to receiving the request 205, cloud data center 202 generates and deploys a new edge neural network 211 to the new edge server 209. In some examples, as part of this process, metadata is extracted and amalgamated from users/devices that are expected to connect to the new edge server 209. The metadata is amalgamated into anticipated edge devices information 207, which is provided to neural network breeding module 206. The anticipated edge devices information 207 may include, for example, a physical location of each edge device that is expected to access the new edge server 209, expected inputs from those edge devices that are expected to be sent to the new edge neural network 211, and other metadata associated with each edge device that is expected to access the new edge server 209.

In some examples, in response to receiving the request 205, neural network breeding module 206 requests, from each of the edge servers 212, the current edge neural network 214 at that edge server 212, the fitness measure 218, and its associated edge devices information 222. This requested information is provided by the edge servers 212 to the neural network breeding module 206, and the neural network breeding module 206 then performs a neural network breeding operation between one or more of the received edge neural networks 214 to generate the new edge neural network 211, which is deployed to the new edge server 209. In some examples, cloud data center 202 may determine at least some of the anticipated edge devices information 207 by identifying, based on the edge devices information 222 received from the edge servers 212, edge devices that are at a physical location that is within a threshold proximity of the physical location of the new edge server 209 (which may be specified in the request 205), and then using inputs previously provided by the identified edge devices as at least part of the anticipated edge devices information 207.

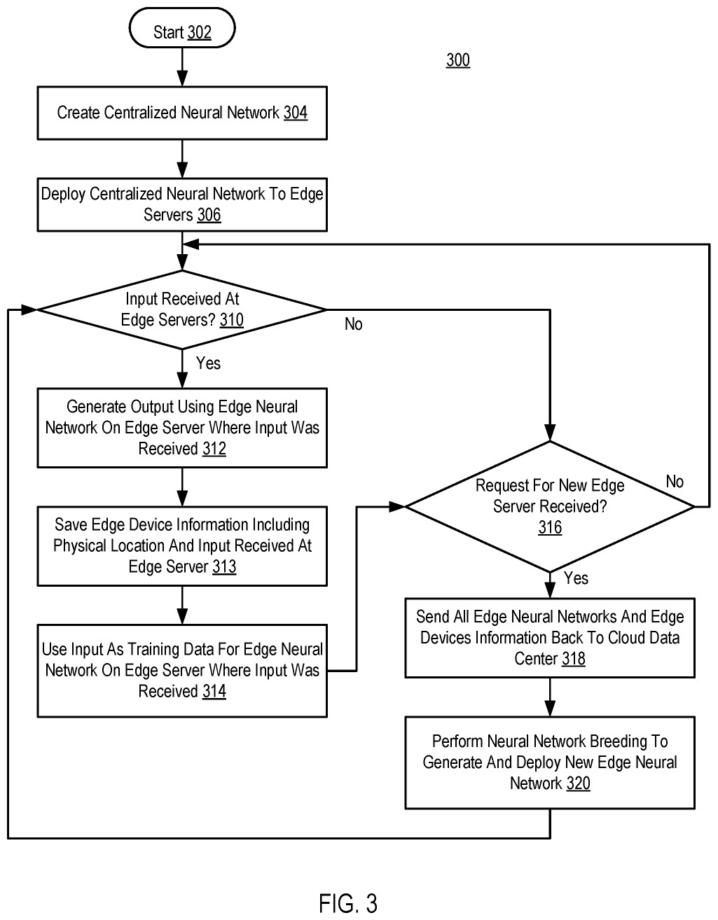

In some examples, as part of the neural network breeding operation, the neural network breeding module 206 compares, for each of the edge servers 212, the edge devices information 222 from that edge server 212 to the anticipated edge devices information 207 to determine a comparison percentage for each of the edge servers 212. For each of the edge servers 212, if the comparison percentage for that edge server 212 is above a threshold level, the edge neural network 214 of that edge server 212 is selected for breeding. In some examples, each of the selected edge neural networks 214 is assigned a weight factor based on their associated comparison percentage. In some examples, the weight factors for all the selected edge neural networks adds to 1 (i.e., 100%). Neural network breeding module 206 then performs neural network breeding on the selected edge neural networks 214 using the assigned weight factors. The result of the neural network breeding is a new edge neural network 211, which is deployed to the new edge server 209. The system 200 shown in FIG. 2 is described in further detail below with reference to FIG. 3.

FIG. 3 sets forth a flowchart of an example method 300 for deploying a neural network to a new edge server in an edge computing environment according to aspects of the present disclosure. In a particular embodiment, the method 300 of FIG. 3 is performed by system 200 (FIG. 2) utilizing the new edge neural network generation and deployment code 107, which includes neural network breeding module 206, neural network training modules 216, and neural network breeding modules 220. The method 300 of FIG. 3 starts at 302, and includes creating 304 a centralized neural network. In some examples, the centralized neural network in method 300 may be centralized neural network 204 that is initially created within cloud data center 202 using training data 208. The method 300 further includes deploying 306 the centralized neural network to a plurality of edge servers. In some examples, cloud data center 202 deploys the most updated version of the centralized neural network 204 at 306 in method 300, and the edge servers in method 300 may be edge servers 212, which may each store a received copy of the centralized neural network as edge neural network 214.

The method 300 further includes determining, at 310, whether input has been received at any of the edge servers. In some examples, each of the edge servers 212 operates independently and waits for input from edge devices (e.g., Internet of Things (IoT) devices, autonomous vehicles, mobile devices, etc.) to be processed by their edge neural network 214. If it is determined at 310 that input has been received at the edge servers, the method 300 moves to 312, which includes generating 312 output using the edge neural network on the edge server where the input was received. In some examples, the output is provided to the edge device that provided the input to the edge server. The method 300 further includes saving 313 edge device information including physical location and input received at the edge server. In some examples, each time an edge device accesses one of the edge servers 212 and provides input for the edge neural network 214 at that edge server 212, the physical location of that edge device and the input provided by that edge device are saved in the edge devices information 222 at that edge server 212. The method 300 further includes using 314 the input as training data for the edge neural network on the edge server where the input was received, and the method 300 moves to 316. In some examples, the neural network training module 216 on the edge server 212 where the input was received uses that input as training data for the edge neural network 214 on that edge server 212 in method 300. The neural network training module 216 may use reinforcement learning, back-propagation, or other methods for the training. Because only the edge neural network that received the input is being trained and updated based on that input, the edge neural networks may begin to drift and differ from one another.

If it is determined at 310 that input has not been received at the edge servers, the method 300 moves to 316, which includes determining whether a request for a new edge server has been received. In some examples, the request at 316 in method 300 may be request 205 and may include an identification of a physical location of new edge server 209. If it is determined at 316 that a request for a new edge server has not been received, the method 300 returns to 310 to again determine whether input has been received at the edge servers. Thus, the edge neural networks are allowed to continue to operate, train, and update independently.

If it is determined at 316 that a request for a new edge server has been received, the method 300 moves to 318, which includes sending all edge neural networks and corresponding edge devices information back to a cloud data center. In some examples, in response to receiving a request 205 for a new edge server, cloud data center 202 notifies the edge servers 212 at 318, and in response, the edge servers 212 send their respective edge neural networks 214 and associated edge devices information 222 to the cloud data center 202. In some embodiments, fitness measures 218 are also sent back to cloud data center 202.

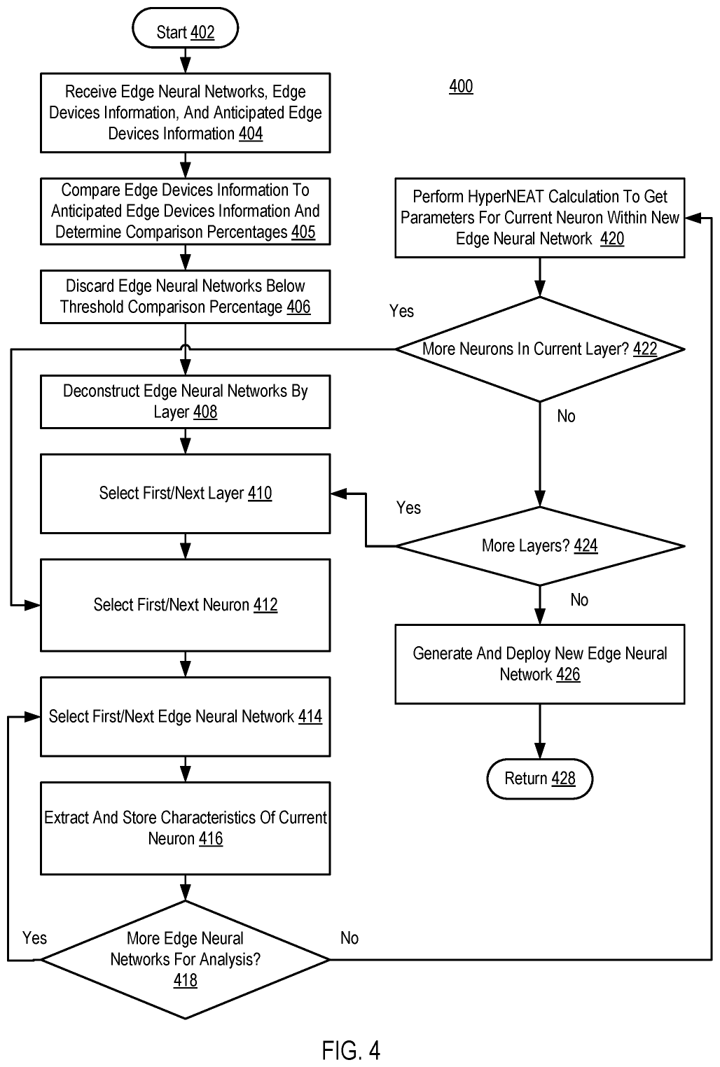

The method 300 further includes performing 320 neural network breeding to generate and deploy a new edge neural network for the new edge server, and then the method 300 returns to 310 to again determine whether input has been received at the edge servers. In some examples, neural network breeding module 206 performs the breeding in method 300 to generate new edge neural network 211 based on the received edge neural networks 214, edge devices information 222, and anticipated edge devices information 207, as described in further detail below with reference to FIG. 4.

FIG. 4 sets forth a flowchart of an example method 400 for generating a new edge neural network for a new edge server according to aspects of the present disclosure. In a particular embodiment, the method 400 of FIG. 4 is performed utilizing the neural network breeding module 206, which is part of the new edge neural network generation and deployment code 107, and which, in some examples, performs breeding of one or more of the edge neural networks 214 to generate a new edge neural network 211. The method 400 may be implemented as part of the breeding at 320 in method 300. The method 400 of FIG. 4 starts at 402, and includes receiving 404 edge neural networks, edge devices information, and anticipated edge devices information. In an example, neural network breeding module 206 receives edge neural networks 214, fitness measures 218, and edge devices information 222 from edge servers 212, and also receives or determines anticipated edge devices information 207.

The method 400 further includes comparing 405 the edge devices information to the anticipated edge devices information for the new edge server and determining comparison percentages. In some examples, for each of the edge servers 212, neural network breeding module 206 compares the edge devices information 222 from that edge server 212 to the anticipated edge devices information 207 to determine a comparison percentage associated with the edge neural network 214 at that edge server 212. The method 400 further includes discarding 406 edge neural networks that are below a threshold comparison percentage. In some examples, the neural network breeding module 206 discards any of the edge neural networks 214 that has an associated comparison percentage that is below the threshold comparison percentage, and does not use such edge neural networks 214 as part of the breeding.

The method 400 further includes deconstructing 408 edge neural networks by layer. In some examples, the method 400 may alternatively decouple the entire set of layers into an array and then iterate through the list, rather than using nested loops as shown in FIG. 4. The method 400 further includes selecting 410 a first/next layer in the edge neural networks being analyzed. During the first pass through the selecting at 410, a first layer in the edge neural networks is selected, and during subsequent passes, other layers in the edge neural networks are selected. An iteration loop begins/continues at 410 in method 400 by selecting the first/next layer that will be analyzed. For example, if the edge neural networks 214 being analyzed have 10 layers, then the method 400 will iterate through all 10 layers, one at a time. In some examples, all of the edge neural networks 214 have the same structure (i.e., same number of layers and same number of neurons within each layer). From layer to layer, the number of neurons may differ (e.g., all the edge neural networks 214 may have 5 neurons in layer 1, 7 neurons in layer 2, etc.). In some examples, one or more of the edge neural networks 214 have a different structure (i.e., different number of layers and/or different number of neurons within each layer). In these examples, the HyperNEAT calculation at 420 may include performing a weighted average of only similar neurons between the neural networks being breeded and those new neurons may be added to the updated neural network at that edge node.

The method 400 further includes selecting 412 a first/next neuron in the selected layer of the edge neural networks. During the first pass through the selecting at 412, a first neuron in the selected layer is selected, and during subsequent passes, other neurons in the selected layer are selected. A nested loop begins/continues at 412 in method 400 where the first/next neuron within the currently selected layer is selected for analysis. For example, if layer 1 contains 5 neurons in all of the edge neural networks 214, the method 400 will iterate through all 5, one at a time.

The method 400 further includes selecting 414 a first/next edge neural network. Another nested loop begins/continues at 414 in method 400 where the first/next edge neural network is selected for analysis. For example, if there are 5 edge neural networks 214 being analyzed, the method 400 will iterate through all 5, one at a time.

The method 400 further includes extracting and storing 416 characteristics of the currently selected neuron. In some examples, the characteristics of the currently selected neuron within the currently selected layer within the currently selected edge neural network 214 may be extracted and stored in a data structure. The characteristics at 416 in method 400 may include weights, biases, activation functions, dependencies, etc.

At 418 in method 400, it is determined whether more edge neural networks are to be analyzed. If it is determined at 418 that there are more edge neural networks to be analyzed, the method 400 returns to 414 to select the next edge neural network to be analyzed. If it is determined at 418 that there are no more edge neural networks to be analyzed, the method 400 moves to 420.

The method 400 further includes performing 420 a HyperNEAT calculation to get parameters for the currently selected neuron in the currently selected layer within what will become a new edge neural network. In some examples, the HyperNEAT calculation at 420 involves performing a weighted average (based on the comparison percentages determined at 405 in method 400) of the parameters extracted from each neuron. In some examples, each of the selected edge neural networks 214 is assigned a weight factor based on their associated comparison percentage. In some examples, the weight factors for all the selected edge neural networks adds to 1 (i.e., 100%).

At 422 in method 400, it is determined whether there are more neurons in the currently selected layer to be analyzed. If it is determined at 422 that there are more neurons in the currently selected layer to be analyzed, the method 400 returns to 412 to select the next neuron. If it is determined at 422 that there are not more neurons in the currently selected layer to be analyzed, the method 400 moves to 424.

At 424 in method 400, it is determined whether there are more layers in the edge neural networks to be analyzed. If it is determined at 424 that there are more layers to be analyzed, the method 400 returns to 410 to select the next layer. If it is determined at 424 that there are not more layers to be analyzed, the method 400 moves to 426. The method 400 further includes generating and deploying 426 a new edge neural network. In some examples, neural network breeding module 206 generates new edge neural network 211 based on the characteristics extracted at 416 and the HyperNEAT calculations performed at 420, and deploys the new edge neural network 211 to new edge server 209. At 428, the method 400 may return to method 300 at 310, for example.

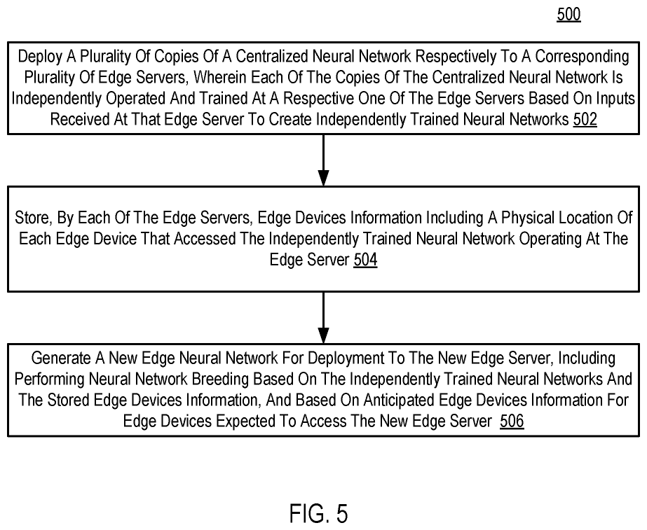

FIG. 5 sets forth a flowchart of an example method 500 for deploying a neural network to a new edge server in an edge computing environment according to another aspect of the present disclosure. In a particular embodiment, the method 500 of FIG. 5 is performed by system 200 (FIG. 2) utilizing the new edge neural network generation and deployment code 107, which includes neural network breeding module 206, neural network training modules 216, and neural network breeding modules 220. The method 500 includes deploying 502 a plurality of copies of a centralized neural network respectively to a corresponding plurality of edge servers, wherein each of the copies of the centralized neural network is independently operated and trained at a respective one of the edge servers based on inputs received at that edge server to create independently trained neural networks. The method 500 further includes storing 504, by each of the edge servers, edge devices information including a physical location of each edge device that accessed the independently trained neural network operating at the edge server. The method 500 further includes generating 506 a new edge neural network for deployment to the new edge server, including performing neural network breeding based on the independently trained neural networks and the stored edge devices information, and based on anticipated edge devices information for edge devices expected to access the new edge server. In some examples, the method 500 may also include receiving, at a cloud-based data center, a request for the new edge server including a physical location of the new edge server; sending, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and deploying, from the cloud-based data center to the new edge server, the new edge neural network.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for deploying a neural network to a new edge server in an edge computing environment, comprising:
deploying a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
storing, by each of the edge servers, edge devices information including a physical location of each edge device that accessed the independently trained neural network operating at the edge server; and
generating a new edge neural network for deployment to the new edge server, including performing neural network breeding based on the independently trained neural networks and the stored edge devices information, and based on anticipated edge devices information for edge devices expected to access the new edge server.

2. The method of claim 1, and further comprising:
receiving, at a cloud-based data center, a request for the new edge server including a physical location of the new edge server;
sending, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and
deploying, from the cloud-based data center to the new edge server, the new edge neural network.

3. The method of claim 1, wherein, for each of the edge servers, the stored edge devices information further includes inputs provided by edge devices to the independently trained neural network operating at the edge server.

4. The method of claim 1, wherein the anticipated edge devices information includes inputs expected to be provided by edge devices to the new edge server.

5. The method of claim 1, and further comprising:
comparing, for each of the edge servers, the edge devices information from the edge server to the anticipated edge devices information for the new edge server to determine a comparison percentage corresponding to the independently trained neural network operating on the edge server.

6. The method of claim 5, wherein the neural network breeding includes discarding any copies of the independently trained neural networks that have a corresponding comparison percentage below a threshold comparison percentage.

7. The method of claim 5, wherein the neural network breeding includes selecting top matching copies of the independently trained neural networks to be used for the neural network breeding based on the comparison percentage corresponding to each of the copies of the independently trained neural networks.

8. The method of claim 5, wherein the neural network breeding includes performing a hyperNEAT calculation that includes determining a weighted average, based on the comparison percentages, of parameters extracted from neurons in one or more of the copies of the independently trained neural networks.

9. An apparatus for deploying a neural network to a new edge server in an edge computing environment, comprising:
a processing device; and
memory operatively coupled to the processing device, wherein the memory stores computer program instructions that, when executed, cause the processing device to:
deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
store, by each of the edge servers, edge devices information including a physical location of each edge device that accessed the independently trained neural network operating at the edge server; and
generate a new edge neural network for deployment to the new edge server, including performing neural network breeding based on the independently trained neural networks and the stored edge devices information, and based on anticipated edge devices information for edge devices expected to access the new edge server.

10. The apparatus of claim 9, wherein the memory stores computer program instructions that, when executed, cause the processing device to:
receive, at a cloud-based data center, a request for the new edge server including a physical location of the new edge server;
send, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and
deploy, from the cloud-based data center to the new edge server, the new edge neural network.

11. The apparatus of claim 9, wherein, for each of the edge servers, the stored edge devices information further includes inputs provided by edge devices to the independently trained neural network operating at the edge server.

12. The apparatus of claim 9, wherein the anticipated edge devices information includes inputs expected to be provided by edge devices to the new edge server.

13. The apparatus of claim 9, wherein the memory stores computer program instructions that, when executed, cause the processing device to:
compare, for each of the edge servers, the edge devices information from the edge server to the anticipated edge devices information for the new edge server to determine a comparison percentage corresponding to the independently trained neural network operating on the edge server.

14. The apparatus of claim 13, wherein the neural network breeding includes discarding any copies of the independently trained neural networks that have a corresponding comparison percentage below a threshold comparison percentage.

15. The apparatus of claim 13, wherein the neural network breeding includes selecting top matching copies of the independently trained neural networks to be used for the neural network breeding based on the comparison percentage corresponding to each of the copies of the independently trained neural networks.

16. The apparatus of claim 13, wherein the neural network breeding includes performing a hyperNEAT calculation that includes determining a weighted average, based on the comparison percentages, of parameters extracted from neurons in one or more of the copies of the independently trained neural networks.

17. A computer program product for deploying a neural network to a new edge server in an edge computing environment, comprising a computer readable storage medium, wherein the computer readable storage medium comprises computer program instructions that, when executed:
deploy a plurality of copies of a centralized neural network respectively to a corresponding plurality of edge servers, wherein each of the copies of the centralized neural network is independently operated and trained at a respective one of the edge servers based on inputs received at that edge server to create independently trained neural networks;
store, by each of the edge servers, edge devices information including a physical location of each edge device that accessed the independently trained neural network operating at the edge server; and
generate a new edge neural network for deployment to the new edge server, including performing neural network breeding based on the independently trained neural networks and the stored edge devices information, and based on anticipated edge devices information for edge devices expected to access the new edge server.

18. The computer program product of claim 17, wherein the computer readable storage medium further comprises computer program instructions that, when executed:
receive, at a cloud-based data center, a request for the new edge server including a physical location of the new edge server;
send, from each of the edge servers to the cloud-based data center, a copy of the independently trained neural network operating at the edge server and the edge devices information stored by the edge server, wherein the cloud-based data center generates the new edge neural network in response to the request based on the copies of the independently trained neural networks sent from the edge servers; and
deploy, from the cloud-based data center to the new edge server, the new edge neural network.

19. The computer program product of claim 17, wherein the computer readable storage medium further comprises computer program instructions that, when executed:
compare, for each of the edge servers, the edge devices information from the edge server to the anticipated edge devices information for the new edge server to determine a comparison percentage corresponding to the independently trained neural network operating on the edge server.

20. The computer program product of claim 19, wherein the neural network breeding includes performing a hyperNEAT calculation that includes determining a weighted average, based on the comparison percentages, of parameters extracted from neurons in one or more of the copies of the independently trained neural networks.
